(19) United States
(12) Patent Application Publication
(10) Pub. No.: US 2024/0192329 A1
(43) Pub. Date: Jun. 13, 2024

(54) ADJUSTMENT OF LIGHT DETECTION AND RANGING (LIDAR) SYSTEM FIELD OF VIEW DURING OPERATION

(71) Applicant: Aeva, Inc., Mountain View, CA (US)

(72) Inventors: Cameron Howard, Bend, OR (US); Sawyer Isaac Cohen, Menlo Park, CA (US)

(21) Appl. No.: 18/065,310

(22) Filed: Dec. 13, 2022

(51) Int. Cl. G01S 7/481; G01S 7/4913; G01S 17/34

(52) U.S. Cl. CPC G01S 7/4817; G01S 7/4814; G01S 7/4913; G01S 17/34; G02B 26/129

(57) ABSTRACT

Aspects of the present disclosure provide light detection and ranging (LIDAR) systems and methods for changing or adjusting field of view (FOV) during operation. Changing the FOV may include transmitting an optical beam toward a target, and forming the FOV using the optical beam via a first rotating reflector and a second rotating reflector. The first rotating reflector may include a galvo mirror in control of the vertical FOV, and the second rotating reflector may include a rotating polygon mirror in control of and providing for the horizontal FOV. The FOV may be adjusted in the vertical direction by actuating the first rotating reflector along a vertical direction using a first actuator. The first actuator may determine the actuation based on an orientation of the LIDAR system (e.g., a difference between an initial orientation measured after installation and a baseline orientation referencing a horizontal orientation).

### FIELD

The present disclosure is related to light or laser image detection and ranging (LIDAR) systems.

### BACKGROUND

Frequency-Modulated Continuous-Wave (FMCW) light detection and ranging (LIDAR) systems use tunable lasers for frequency-chirped illumination of targets and coherent receivers for detection of backscattered or reflected light from the targets that are combined with a local copy of the transmitted signal (e.g., local oscillator or “LO” signal). Mixing the LO signal with the return signal, delayed by the round-trip time to the target and back, generates a beat frequency at the receiver that is proportional to the distance to each target in the field of view (FOV) of a LIDAR system.

These LIDAR systems employ optical scanners with high-speed mirrors to scan a FOV and to de-scan target return signals from the FOV. Multiple beams are generally implemented in a LIDAR system to scan multiple lines in a common FOV simultaneously. A LIDAR system often has a fixed FOV, e.g., the laser beam scanning coverage in the horizontal and vertical directions (characterized as horizontal FOV and vertical FOV) are often fixed or non-adjustable during operation. Therefore, when the LIDAR system is mounted pointing upward or downward, the vertical FOV can be negatively impacted (e.g., losing coverage when the horizon is offset excessively in the vertical FOV).

For various aerodynamics, aesthetics, or vehicle mounting options reasons, a LIDAR system may be mounted at different orientations relative to the global horizon (e.g., a LIDAR system may be mounted flat on top of a vehicle roof pointing forward or mounted on a back windshield of the vehicle pointing downwards). As a result, the fixed FOV of the LIDAR system may not cover an ideal scene, such as having the horizon at a certain position of the FOV in order to measure traffic or obstacles of the surrounding of the LIDAR system. Conventionally, to compensate for the variations caused by the mounting variations, the sizes of the optical components in the LIDAR system must increase to compensate for increasing the FOV. The size increase of the optical components may undesirably lead to an overall increase of the LIDAR system and production cost.

### SUMMARY

The present disclosure describes various examples of light or laser image detection and ranging (LIDAR) systems and methods for adjusting, during operation via internal optical components, a field of view (FOV) of LIDAR systems without increasing the overall system size.

In one example, a frequency-modulated continuous wave (FMCW) LIDAR system according to the present disclosure includes an optical source to transmit an optical beam toward a target via a first rotating reflector and a second rotating reflector to form a field of view (FOV). The LIDAR system includes the first rotating reflector, which is adjustable along a vertical direction to adjust the FOV in a first direction (e.g., by adjusting the first rotating reflector in the vertical direction, the resulting FOV may also be adjusted in the first direction). The LIDAR system further includes the second rotating reflector to provide for the FOV in a second direction perpendicular to the first direction. The LIDAR system includes an actuator operatively coupled to the first rotating reflector to dynamically adjust the first rotating reflector along the vertical direction for adjusting the FOV in the first direction based on an orientation of the FMCW LIDAR system. The LIDAR system further includes an optical receiver adapted to receive at least a returned portion of the optical beam transmitted toward the target.

In some embodiments, the second rotating reflector is adjustable to adjust the FOV in the second direction. The FMCW LIDAR system may further include a second actuator to adjust the second rotating reflector.

In some embodiments, the first rotating reflector includes a galvo mirror (e.g., a mirror galvanometer mechanism or system) and the second rotating reflector comprises a polygon mirror.

In some embodiments, the actuator is to secure the first rotating reflector at various vertical positions relative to the second rotating reflector. For example, the change of the relative positions between the first and the second rotating reflectors causes the adjustment of the FOV in the first direction. In some cases, in response to a change of the orientation of the FMCW LIDAR system, the actuator maintains the FOV in the first direction at the various orientations.

In some embodiments, the first direction is perpendicular to the ground and the second direction is parallel to the ground.

In some embodiments, the actuator comprises a guide along which the first rotating reflector is affixed at different pre-determined, pre-configured, or preset positions during adjustment. In some cases, the actuator further includes one or more reference spacers corresponding to one or more vertical projection angles of the orientation of the FMCW LIDAR system to allow for accurate positioning of the first rotating reflector.

In one example, a method of changing vertical projection and detection angles of a FMCW LIDAR system includes transmitting an optical beam toward a target and forming a field of view (FOV) using the optical beam via a first rotating reflector and a second rotating reflector. The method may further include adjusting the FOV in a first direction by actuating the first rotating reflector along a vertical direction using a first actuator based on an orientation of the FMCW LIDAR system. The FOV may be provided via the second rotating reflector in a second direction perpendicular to the first direction. The method further includes receiving, by an optical receiver, a returned portion of the optical beam.

In some embodiments, forming the FOV further includes adjusting the FOV in the second direction by adjusting the second rotating reflector using a second actuator.

In some embodiments, the method further includes securing, by the first actuator, the first rotating reflector at various vertical positions relative to the second rotating reflector. In some cases, the method further includes, in response to a change of the orientation of the FMCW LIDAR system, maintaining, by the actuator, the FOV in the first direction at the various vertical positions. In some cases, the first direction is perpendicular to a ground and the second direction is parallel to the ground. In some cases, the method further includes affixing the first rotating reflector along a guide of the first actuator at different positions during adjusting the FOV. For example, affixing the first rotating reflector along the guide may include spacing, with one or more reference spacers corresponding to one or more vertical projection angles of the orientation of the FMCW LIDAR system, the first rotating reflector relative to the second rotating reflector to allow for accurate positioning of the first rotating reflector.

In one example, a LIDAR system includes a laser diode for transmitting an optical beam toward a target via one or more optics that include a first rotating reflector and a second rotating reflector to form a field of view (FOV). The first rotating reflector is adjustable along a vertical direction to adjust the FOV in a first direction. The second rotating reflector may provide for the FOV in a second direction perpendicular to the first direction. The LIDAR system further includes an actuator operatively coupled to the first rotating reflector or the second rotating reflector to dynamically adjust the first rotating reflector along the vertical direction for adjusting the FOV in the first direction based on an orientation of the LIDAR system. The LIDAR system includes an optical receiver adapted to receive at least a returned portion of the optical beam transmitted toward the target.

In some embodiments, the actuator is controlled by a controller receiving feedback regarding the orientation of the LIDAR system. In some cases, the actuator may secure the first rotating reflector at various vertical positions relative to the second rotating reflector, or vice versa.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 illustrates an example of a light detection and ranging (LIDAR) system according to embodiments of the present disclosure.

FIG. 2 is a time-frequency diagram illustrating an example of LIDAR waveforms according to embodiments of the present disclosure.

FIG. 3A is a top view of an example reflector configuration for producing a horizontal field of view (FOV) of a LIDAR system, according to embodiments of the present disclosure.

FIG. 3B is a side view of the example reflector configuration of FIG. 3A, for producing a vertical FOV of the LIDAR system, according to embodiments of the present disclosure.

FIG. 3C is a side view of the example reflector configuration of FIGS. 3A-3B for adjusting the FOV of the LIDAR system, according to embodiments of the present disclosure.

FIG. 4 is a block diagram of an example LIDAR system implementing FOV adjustment during operation, according to embodiments of the present disclosure.

FIG. 5 is a flowchart illustrating an example method for adjusting FOV of a LIDAR system during operation, according to embodiments of the present disclosure.

Like numerals indicate like elements.

### DETAILED DESCRIPTION

The present disclosure describes various examples of light or laser image detection and ranging (LIDAR) systems and methods for changing or adjusting field of view (FOV) during operation. For example, one or more optical elements in the LIDAR system may receive physical actuation to dynamically alter the FOV of a scanning laser of the LIDAR system.

According to some embodiments, the described LIDAR system may be implemented in any sensing market, such as, but not limited to, transportation, manufacturing, metrology, medical, and security systems. According to some embodiments, the described LIDAR system can be implemented as part of a front-end of frequency modulated continuous-wave (FMCW) device that assists with spatial awareness for automated driver assist systems, or self-driving vehicles.

According to aspects of the present disclosure, techniques and methods of changing vertical projection and detection angles (e.g., the FOV in the vertical direction) may include transmitting an optical beam toward a target, and forming the FOV using the optical beam via a first rotating reflector and a second rotating reflector. For example, the first rotating reflector may include a galvo mirror (e.g., an oscillating reflector) in control of the vertical FOV (e.g., scanning the optical beam up and down), and the second rotating reflector may include a rotating polygon mirror in control of and providing for the horizontal FOV (e.g., scanning the optical beam left and right). The FOV may be adjusted in the vertical direction by actuating the first rotating reflector along a vertical direction using a first actuator (e.g., a linear servo or actuator). The first actuator may determine the actuation based on an orientation of the LIDAR system (e.g., a difference between an initial orientation measured after installation and a baseline orientation referencing a horizontal orientation).

Conventionally, the FOV in the vertical direction is dictated by the polygon facet height of the second rotating reflector while the relative positions of the first and the second rotating reflectors are permanently fixed. The polygon facet height is sized according to a final vertical field of view required by the specifications of a particular LIDAR system. To change the vertical FOV, the polygon facet height may be increased or the fixed position may be further offset, leading to the increase of the size (such as a thickness) of other components or the LIDAR system as a whole (e.g., the housing of the LIDAR system). These changes are costly and may not be adaptable to uncertain operation or mounting conditions.

The present disclosure provides systems, methods, and techniques for adjusting the FOV during operation without causing size increases. For example, the present disclosure provides changing of the vertical position of the first rotating reflector to cause the vertical FOV of the LIDAR system to be adjusted based on the orientation. By adjusting the vertical position of the first rotating reflector with respect to the second rotating reflector, and adjusting the vertical scan angles of the first rotating reflector, the vertical field of view of the LIDAR system may be adjusted and controlled without increasing the volume of any of the subcomponents of the LIDAR system (or the external envelope of the LIDAR system). The adjustment or control of the vertical FOV enables the LIDAR system to maintain the FOV in response to changes to the orientation (e.g., when a vehicle changes pitch locally due to road obstacles while the LIDAR system maintains a constant global FOV relative to the horizon).

In some implementations, the vertical position of the second rotating reflector may be adjusted to achieve a similar effect (e.g., as long as the relative positions are altered). The shift in the vertical position of the first or the second rotating reflector may be controlled via an actuator such as a linear actuator. The linear actuator enables the LIDAR system to continuously adjust the vertical FOV dynamically based on a measured orientation of the LIDAR system. For example, the LIDAR system adjusts the vertical FOV when the orientation varies relative to the ground or horizon, such as when a vehicle moves along in different inclined surfaces. At certain positions and when consistency is preferred over dynamic adjustment, the first or the second rotating reflector may be affixed at certain positions by fastening means (e.g., set screws or a locking mechanism). The certain positions may reference to preset, pre-configured, or pre-defined reference spacers (e.g., for achieving known or preset FOVs). Various examples and detailed examples of the actuator for the first and/or the second rotating actuators are discussed in detail below.

LIDAR systems described by the embodiments herein include coherent scan technology that includes the use of transmission lines, one or more sensors, receivers, and at least one local oscillator (i.e., a local copy of the transmission line). A scanning element (e.g., galvo mirror) is used to transmit the beam of light towards targets in the field of view of a sensor used by LIDAR systems described herein. A beam reflected from the target is collected by a lens system and combined with the local oscillator. As mirror speeds are increased, mirror movement during the round trip time to and from a target, especially for distant targets, can cause light returned from the target to be slightly off angle with respect to a scanning mirror at the time of the arrival of the returned light at a receiver. The lag angle can result in degradation of the signal-to-noise ratio at sensors of the receiver. Using the techniques described herein, embodiments of the present invention can, among other things, address the issues described above by providing an expanded field of view of the receiver on a LIDAR system. Multiple waveguides can be provided on a substrate or photonics chip to receive returned beams having different lag angles to increase the field of view of a receiver.

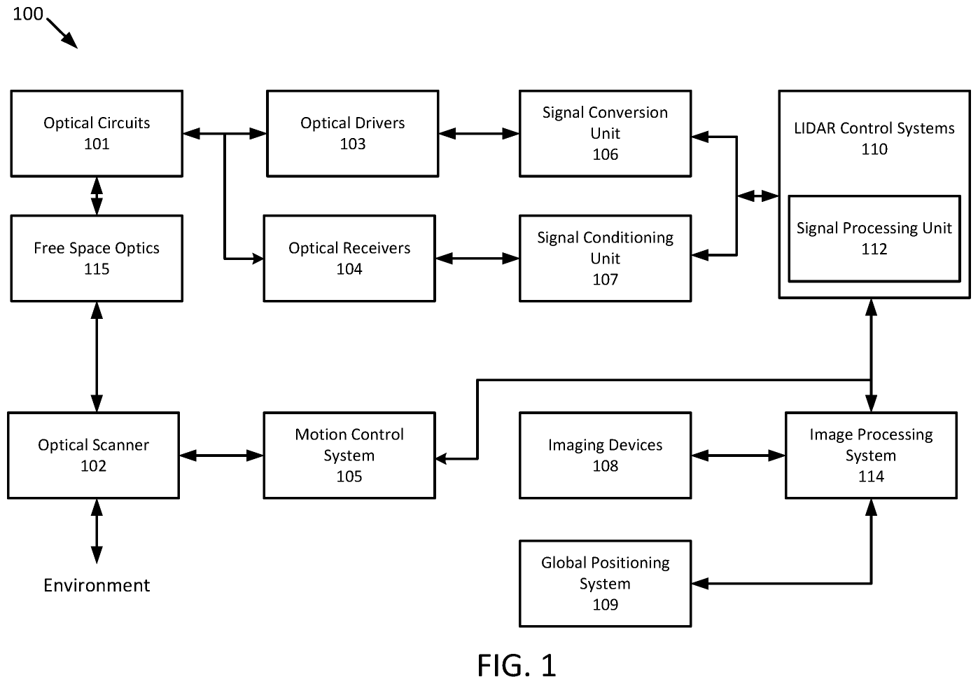

FIG. 1 illustrates a LIDAR system 100 according to example implementations of the present disclosure. The LIDAR system 100 includes one or more of each of a number of components, but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers, non-reciprocal elements such as Faraday rotator or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvo mirrors. The optical scanner 102 also collects light incident upon any objects in the environment into a return optical beam that is returned to the passive optical circuit component of the optical circuits 101. For example, the return optical beam may be directed to an optical detector by a polarization beam splitter. In addition to the mirrors and galvo mirrors, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device such as signal processing unit 112. In some examples, signal processing unit 112 may be one or more general-purpose processing devices such as a microprocessor, central processing unit, or the like. More particularly, signal processing unit 112 may be complex instruction set computing (CISC) microprocessor, reduced instruction set computer (RISC) microprocessor, very long instruction word (VLIW) microprocessor, or processor implementing other instruction sets, or processors implementing a combination of instruction sets. Signal processing unit 112 may also be one or more special-purpose processing devices such as an application specific integrated circuit (ASIC), a field programmable gate array (FPGA), a digital signal processor (DSP), network processor, or the like.

In some examples, signal processing unit 112 is a digital signal processor (DSP). The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvo mirrors of the optical scanner 102 based on control signals received from the LIDAR control systems 110. For example, a digital-to-analog converter may convert coordinate routing information from the LIDAR control systems 110 to signals interpretable by the galvo mirrors in the optical scanner 102. In some examples, a motion control system 105 may also return information to the LIDAR control systems 110 about the position or operation of components of the optical scanner 102. For example, an analog-to-digital converter may in turn convert information about the galvo mirrors' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvo mirrors (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

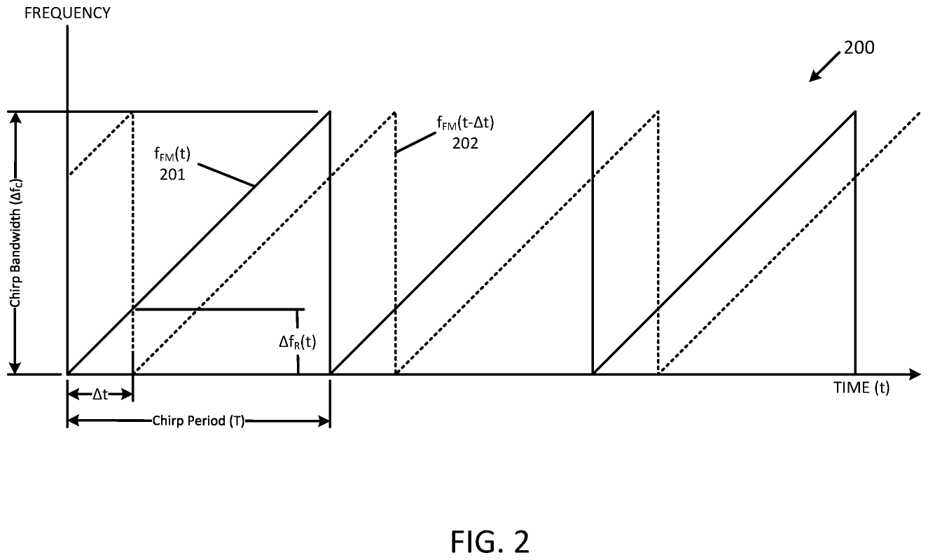

FIG. 2 is a time-frequency diagram 200 of an FMCW scanning signal 201 that can be used by a LIDAR system, such as system 100, to scan a target environment according to some embodiments. In one example, the scanning waveform 201, labeled as f_{FM}(t), is a sawtooth waveform (sawtooth “chirp”) with a chirp bandwidth Δf_{c} and a chirp period T_{c}. The slope of the sawtooth is given as k=(Δf_{c}/T_{c}). FIG. 2 also depicts target return signal 202 according to some embodiments. Target return signal 202, labeled as f_{FM}(t−Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner. It should be noted that while embodiments of the present disclosure may be used in conjunction with FMCW LiDAR, the disclosure is not limited to FMCW LiDAR and embodiment may be used with any other form of coherent LiDAR as well.

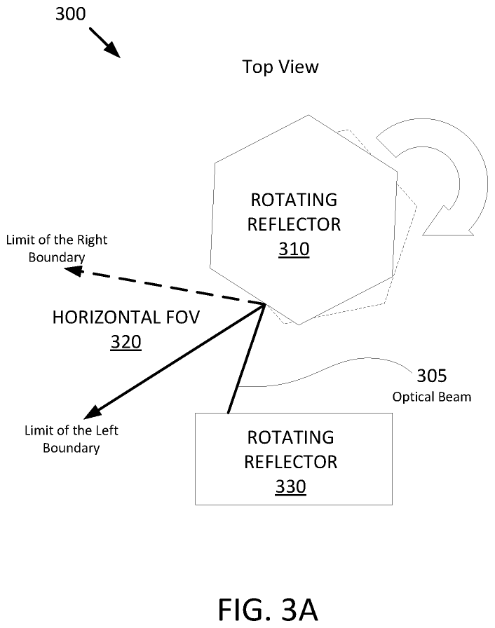

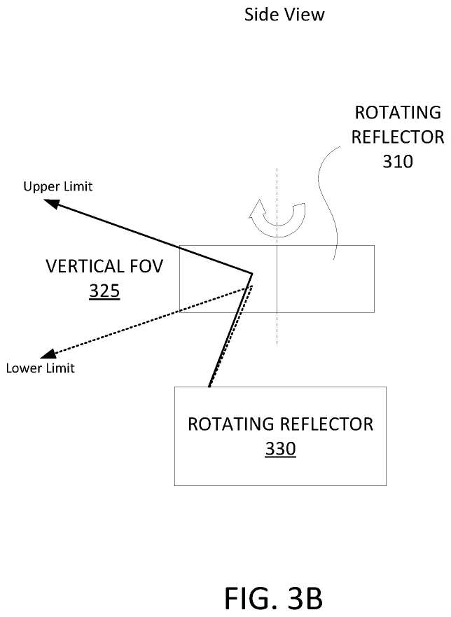

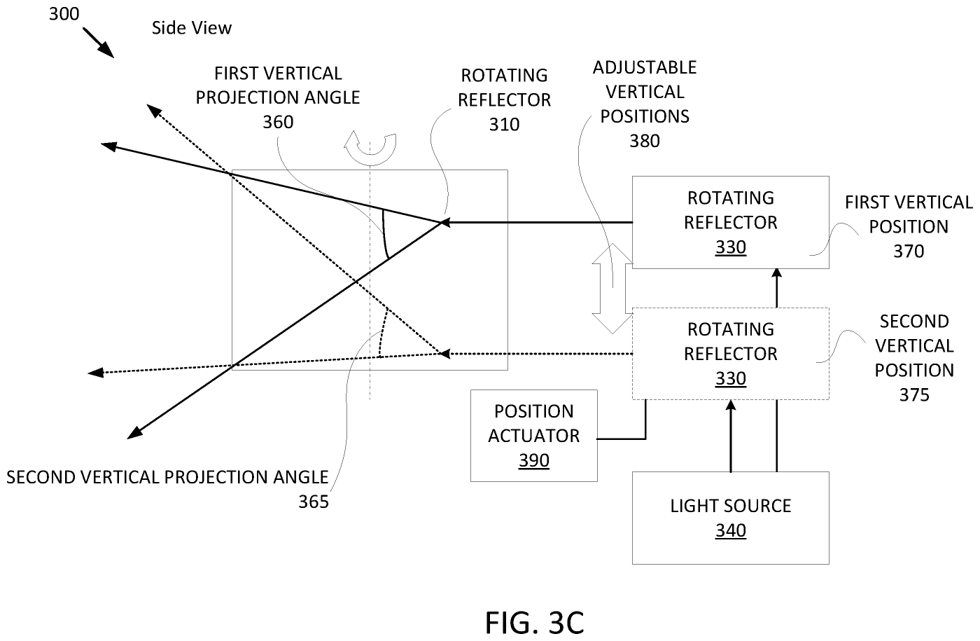

FIG. 3A is a top view of an example reflector configuration 300 for producing a horizontal field of view (FOV) of a LIDAR system, according to embodiments of the present disclosure. FIG. 3B is a side view of the example reflector configuration 300 of FIG. 3A. Referring to FIG. 3A, the rotating reflector 310 receives an optical beam 305 from the rotating reflector 330 (that reflects the optical beam 305 from a light source, such as the light source 340 of FIG. 3C). In the example shown, the rotating reflector 310 is a multi-faceted rotating reflector, and the rotating reflector 330 is a reciprocating or oscillating rotating reflector (e.g., a galvo mirror).

As shown, the rotating reflector 310 (e.g., rotating polygon) adjusts the optical beam 305 in a horizontal plane to provide for the horizontal FOV 320. That is, when the rotating reflector 310 rotates, the rotation causes the optical beam 305 to sweep between the limit of the left boundary 322 and the limit of the right boundary 324 to form the horizontal FOV 320.

In the side view shown in FIG. 3B, the rotating reflector 330 (e.g., a galvo mirror) sweeps the optical beam 305 between a lower limit 328 and an upper limit 326 to produce the vertical FOV 325. In some embodiments, the rotating reflector 330 may be a closed-loop or open-loop (e.g., resonant) controlled. Although FIG. 3B illustrates the rotating reflector 330 being beneath the rotating reflector 310, it should be understood that the rotating reflector 330 may be positioned relative to the rotating reflector 310 in any manner to produce the vertical FOV 325 in specific LIDAR system (e.g., the rotating reflector 330 may be position to the right of the rotating reflector 310).

Although the rotating reflector 310 is illustrated as a polygon mirror in FIGS. 3A and 3B, the rotating reflector 310 may also use a galvo mirror to provide the horizontal FOV 320. Similarly, although the rotating reflector 330 may include a galvo mirror as discussed above, in other embodiments, the rotating reflector 330 may implement a polygon mirror or a different rotating reflector mechanism. The rotating reflectors 310 and 330 may use any reflection, total internal reflection, or refraction mechanism to realize the sweeping operation of the optical beam 305.

FIG. 3C is a side view of the example reflector configuration 300 for adjusting the FOV of the LIDAR system, according to embodiments of the present disclosure. As shown, a position actuator 390 may adjust/actuate the rotating reflector 330 (e.g., a galvo mirror) to various vertical positions 380 during operation, such as, for example, between a vertical position 370 and a different vertical position 375.

When the rotating reflector 330 is at the first vertical position 370, the rotating reflector 330 may reflect the optical beam 305 from the optical source 340 to the rotating reflector 310 to produce a vertical projection angle 360. In some scenarios, vertical projection angle 360 can be defined by the thickness of the rotating reflector 310 and the relative positions of the rotating reflectors 310 and 330. Upon detecting that the LIDAR system changes orientation (e.g., facing downward), the position actuator 390 may move the rotating reflector 330 to the vertical position 375. As a result, the vertical FOV may be adjusted to realize a vertical protection angle 365. This way, the vertical FOV may be adjusted in response to a change of orientation of the LIDAR system, such as to maintain a similar scene coverage by the vertical FOV. In some cases, the position actuator 390 may include a linear actuator, such as a motorized threaded rail positioning the rotating reflector 330 at various vertical positions 380.

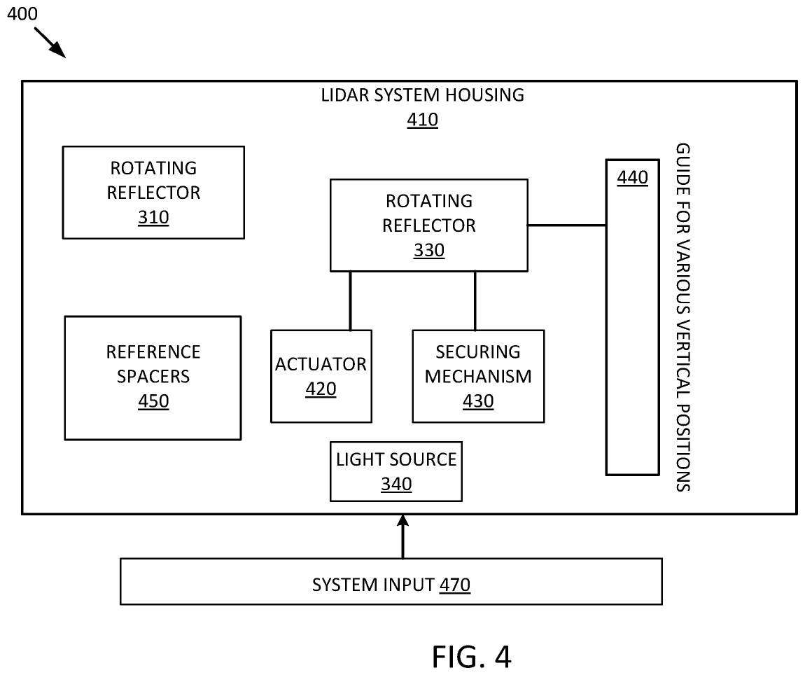

FIG. 4 is a block diagram of an example LIDAR system 400 implementing FOV adjustment during operation, according to embodiments of the present disclosure. As shown, the LIDAR system 400 may include a LIDAR system housing 410. According to aspects of the present disclosure, the FOV of the LIDAR system may be adjusted and altered without increasing the thickness or profile of the LIDAR system housing 410. The LIDAR system housing 410 may enclose, as shown, the light source 340, the actuator 420 (similar to the position actuator 390 of FIG. 3C), a securing mechanism 430, a guide 440 for various vertical positions, one or more reference spacers 450, the rotating reflector 310, and the rotating reflector 330, among other components.

During operation, the actuator 420 may receive the system input 470 which includes data related to measurements or feedback of the orientation of the LIDAR system housing 410. For example, the system input 470 may include measurements by one or more position or orientation sensors, such as gyroscopes, cameras, inertia measurement units (IMUs), accelerometers, and the like. Based on the orientation of the LIDAR system housing 410, the actuator 420 may adjust the position of the rotating reflector 330 along the guide 440.

In some cases, upon positioning the rotating reflector 330 at a position to achieve a target FOV, the securing (e.g., locking) mechanism 430 may affix the rotating reflector 330 on the guide 440, for example, to reduce power consumption by the actuator 420 or to prevent accidental changes due to vibration or other factors. For example, the securing mechanism 430 may include a servo and/or a locking screw configured to temporarily affix the rotating reflector 330 (e.g., a non-moving portion thereof) to the guide 440.

In some embodiments, the securing mechanism 430 may perform the locking operation based on one or more reference spacers 450 (e.g., shims). The reference spacers 450 may provide a calibrated position corresponding to a known vertical FOV of the LIDAR system. The securing mechanism 430 includes the functionality to use (e.g., insert) one of the one or more reference spacers 450 according to a requested vertical FOV to set the rotating reflector 330 and then secure the rotating reflector 330 on the guide 440. In some embodiments, the reference spacers 450 are used during manufacturing. For example, if there are different vertical field of view requirements for a LIDAR system required by multiple customers, different reference spacers 450 may be used to set the relative positions of the reflectors (e.g., the rotating reflector 330) to create different field of views.

Although FIG. 4 illustrates the actuator 420, the securing mechanism 430 and the guide 440 being configured to operate on the rotating reflector 330, the actuator 420, the securing mechanism 430, and the guide 440 or a separate set thereof may also adjust a position of the rotating reflector 310. For example, in some cases, the vertical position of the rotating reflector 310 may also be actuated to change the relative position to the rotating reflector 330.

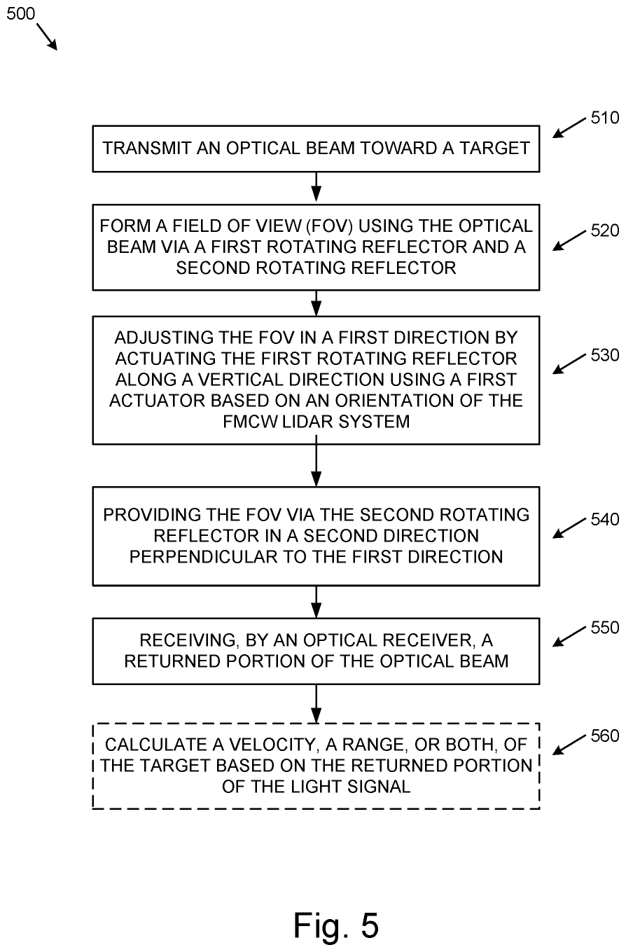

FIG. 5 is a flowchart illustrating an example method or operation 500 in a LIDAR system for adjusting the FOV of the LIDAR system during operation. The method 500 may be performed by a LIDAR system or a processing device in a LIDAR system, such as the LIDAR system 100 or the LIDAR control system 110 of FIG. 1 or the LIDAR system 400 of FIG. 4.

The method 500 begins at 510, by transmitting an optical beam toward a target. For example, the LIDAR system may include a light source, such as a laser diode, and one or more optics to produce the optical beam.

At 520, the method 500 continues by forming a FOV using the optical beam via a first rotating reflector and a second rotating reflector. For example, the first rotating reflector may include a galvo mirror and the second rotating reflector may include a rotating polygon mirror.

At 530, the method 500 adjusts the FOV in a first direction by actuating the first rotating reflector along a vertical direction using a first actuator based on an orientation of the LIDAR system.

At 540, the method 500 provides the FOV via the rotating reflector in a second direction perpendicular to the first direction.

At 550, the method 500 receives, by an optical receiver, a returned portion of the optical beam.

At 560, the method 500 optionally calculates a velocity, a range, or both, of the target based on the returned portion of the light signal.

In some embodiments, forming the FOV further includes adjusting the FOV in the second direction by adjusting the second rotating reflector using a second actuator.

In some embodiments, the method 500 further includes securing, by the first actuator, the first rotating reflector at various vertical positions relative to the second rotating reflector.

In some embodiments, the method 500 further includes maintaining by the actuator, in response to a change of the orientation of the FMCW LIDAR system, the FOV in the first direction at the various vertical positions.

In some embodiments, the first direction is perpendicular to a ground (e.g., the first direction being vertical relative to the horizon) and the second direction is parallel to the ground (e.g., the second direction is horizontal).

In some embodiments, the method 500 further includes affixing the first rotating reflector along a guide of the first actuator at different positions during adjusting the FOV. For example, affixing the first rotating reflector along the guide may include spacing, with one or more reference spacers corresponding to one or more vertical projection angles of the orientation of the LIDAR system, the first rotating reflector relative to the second rotating reflector to allow for an accurate positioning of the first rotating reflector.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A frequency-modulated continuous wave (FMCW) light detection and ranging (LIDAR) system, comprising:
an optical source to transmit an optical beam toward a target via a first rotating reflector and a second rotating reflector to form a field of view (FOV);
the first rotating reflector adjustable along a vertical direction to adjust the FOV in a first direction;
the second rotating reflector to provide for the FOV in a second direction perpendicular to the first direction;
an actuator operatively coupled to the first rotating reflector to dynamically adjust the first rotating reflector along the vertical direction for adjusting the FOV in the first direction based on an orientation of the FMCW LIDAR system; and
an optical receiver adapted to receive at least a returned portion of the optical beam transmitted toward the target.

2. The FMCW LIDAR system of claim 1, wherein the second rotating reflector is adjustable to adjust the FOV in the second direction, and the FMCW LIDAR system further comprises a second actuator.

3. The FMCW LIDAR system of claim 1, wherein the first rotating reflector comprises a galvo mirror and the second rotating reflector comprises a polygon mirror.

4. The FMCW LIDAR system of claim 1, wherein the actuator is to secure the first rotating reflector at various vertical positions relative to the second rotating reflector.

5. The FMCW LIDAR system of claim 4, wherein, in response to a change of the orientation of the FMCW LIDAR system, the actuator maintains the FOV in the first direction at the various vertical positions.

6. The FMCW LIDAR system of claim 1, wherein the first direction is perpendicular to a ground and the second direction is parallel to the ground.

7. The FMCW LIDAR system of claim 1, wherein the actuator comprises a guide along which the first rotating reflector is affixed at different positions during adjustment.

8. The FMCW LIDAR system of claim 7, wherein the actuator further comprises one or more reference spacers corresponding to one or more vertical projection angles of the orientation of the FMCW LIDAR system to allow for accurate positioning of the first rotating reflector.

9. A method of changing vertical projection and detection angles of a frequency-modulated continuous wave (FMCW) light detection and ranging (LIDAR) system, the method comprising:
transmitting an optical beam toward a target;
forming a field of view (FOV) using the optical beam via a first rotating reflector and a second rotating reflector;
adjusting the FOV in a first direction by actuating the first rotating reflector along a vertical direction using a first actuator based on an orientation of the FMCW LIDAR system;
providing the FOV via the second rotating reflector in a second direction perpendicular to the first direction; and
receiving, by an optical receiver, a returned portion of the optical beam.

10. The method of claim 9, wherein forming the FOV further comprises:
adjusting the FOV in the second direction by adjusting the second rotating reflector using a second actuator.

11. The method of claim 9, wherein the first rotating reflector comprises a galvo mirror and the second rotating reflector comprises a polygon mirror.

12. The method of claim 9, further comprising:
securing, by the first actuator, the first rotating reflector at various vertical positions relative to the second rotating reflector.

13. The method of claim 12, further comprising:
in response to a change of the orientation of the FMCW LIDAR system, maintaining, by the actuator, the FOV in the first direction at the various vertical positions.

14. The method of claim 9, wherein the first direction is perpendicular to a ground and the second direction is parallel to the ground.

15. The method of claim 9, further comprising:
affixing the first rotating reflector along a guide of the first actuator at different positions during adjusting the FOV.

16. The method of claim 15, wherein affixing the first rotating reflector along the guide comprises:
spacing, with one or more reference spacers corresponding to one or more vertical projection angles of the orientation of the FMCW LIDAR system, the first rotating reflector relative to the second rotating reflector to allow for accurate positioning of the first rotating reflector.

17. A light detection and ranging (LIDAR) system, comprising:
a laser diode for transmitting an optical beam toward a target via one or more optics comprising a first rotating reflector and a second rotating reflector to form a field of view (FOV), wherein the first rotating reflector is adjustable along a vertical direction to adjust the FOV in a first direction, and wherein the second rotating reflector provides for the FOV in a second direction perpendicular to the first direction;
an actuator operatively coupled to the first rotating reflector or the second rotating reflector to dynamically adjust the first rotating reflector along the vertical direction for adjusting the FOV in the first direction based on an orientation of the LIDAR system; and
an optical receiver adapted to receive at least a returned portion of the optical beam transmitted toward the target.

18. The LIDAR system of claim 17, wherein the actuator is controlled by a controller receiving feedback regarding the orientation of the LIDAR system.

19. The LIDAR system of claim 17, wherein the first rotating reflector comprises a galvo mirror and the second rotating reflector comprises a polygon mirror.

20. The LIDAR system of claim 17, wherein the actuator is to secure the first rotating reflector at various vertical positions relative to the second rotating reflector.
